(19) United States
(12) Patent Application Publication
(10) Pub. No.: US 2003/0093258 A1
(43) Pub. Date: May 15, 2003

(54) Method and apparatus for efficient simulation of memory mapped device access

(76) Inventors: Roman Fishstein, Haifa (IL); Rinat Rappoport, Haifa (IL); Konstantin Levit-Gurevich, Kiryat Byalik (IL); Igor Liokumovich, Netanya (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/999,484

(22) Filed: Nov. 14, 2001

(51) Int. Cl. G06F 9/44; G06F 13/10; G06F 13/12

(52) U.S. Cl. 703/21

(57) ABSTRACT

A system and method of simulating an I/O access is disclosed. A processor is simulated in a virtual machine. The virtual machine operates on a host platform. The simulated processor accesses a first virtual buffer in a simulated I/O device. The first virtual buffer and a second virtual buffer are mapped to a physical memory location in the host platform.

### FIELD OF THE INVENTION

The present invention relates to systems and methods for simulating a processor and more specifically to a system and method providing faster memory access to a simulated processor.

### BACKGROUND OF THE INVENTION

Each type of microprocessor is built to enable a particular instruction set architecture (ISA). For example, the Intel Pentium I family of microprocessors enable the IA32 ISA. New microprocessor families provide new ISAs. Each new ISA has capabilities that set it apart from other ISAs. For example, one ISA may provide simple instructions such as a reduced instruction set computer (RISC) ISA where a second ISA provides for more complex instructions such as a complex instruction set computer (CISC) ISA. Each ISA's capabilities can provide significant advantages over other ISAs for a particular application.

One important factor to the success of a new ISA is the speed of acceptance and development of software designed to use the capabilities of the new ISA. There have been various approaches to providing pre-silicon software development environments to software developers. The pre-silicon, software development environments typically simulate the input/output (I/O) processes of the new ISA. Software developers can use the pre-silicon software development environment to develop applications that will use the ISA of a future generation microprocessor, before the microprocessor has been fully developed into an integrated circuit. This allows the software applications development cycle to at least partially overlap the development cycle of a new microprocessor.

The ISA of a new central processing unit (CPU) is often developed on a simulator before a prototype of the CPU is built. The ISA can be evaluated by executing benchmarks on a host platform that runs the simulator. The new CPU may then be modified or redesigned based on the results produced in the simulator evaluations.

The simulator can also be expanded to simulate the behavior of an entire PC platform, including buses and I/O devices. One benchmark for the simulator may be an Operating System (OS) (called “Simulated” or “Guest” OS). One condition for achieving good performance in an ISA simulation is the efficient simulation of memory accesses. If the simulated CPU and the host CPU architectures are similar (or identical), then the simulated instructions can be allowed to run natively on the host CPU. Thus the simulated memory can be accessed without performing any additional address transformations. However, most operating systems for personal computers assume full control over the PC. Thus, if the simulated OS is allowed to run natively, the simulated OS can conflict with the host OS over PC resources (CPU, devices, memory, etc.).

### BRIEF DESCRIPTION OF THE DRAWINGS

The present invention is illustrated by way of example and not limitation in the figures of the accompanying drawings in which like references indicate similar elements.

FIG. 1 illustrates one embodiment of a system for simulating an ISA.

FIG. 2 illustrates one embodiment of mapping the virtual buffer in a simulated ISA and the virtual buffer in a device simulator to a physical memory.

FIG. 3 illustrates one embodiment of a process for mapping the virtual buffer in a simulated ISA and the virtual buffer in a device simulator to a physical memory.

FIG. 4 illustrates one embodiment of a high-level block diagram of a computer system.

### DETAILED DESCRIPTION

A system and method of simulating an I/O access is disclosed. A processor is simulated in a virtual machine. The virtual machine operates on a host platform. The simulated processor accesses a first virtual buffer in a simulated I/O device. The first virtual buffer and a second virtual buffer are mapped to a physical memory location in the host platform

As described above, if the host OS and the simulated OS are both allowed to run natively on the host platform, then conflicts over resources will ultimately arise. In one embodiment the conflict between the simulated OS and the host OS is resolved by controlling the actions of the simulated OS such that instructions that do not compromise the integrity of the host OS, may be allowed to run natively.

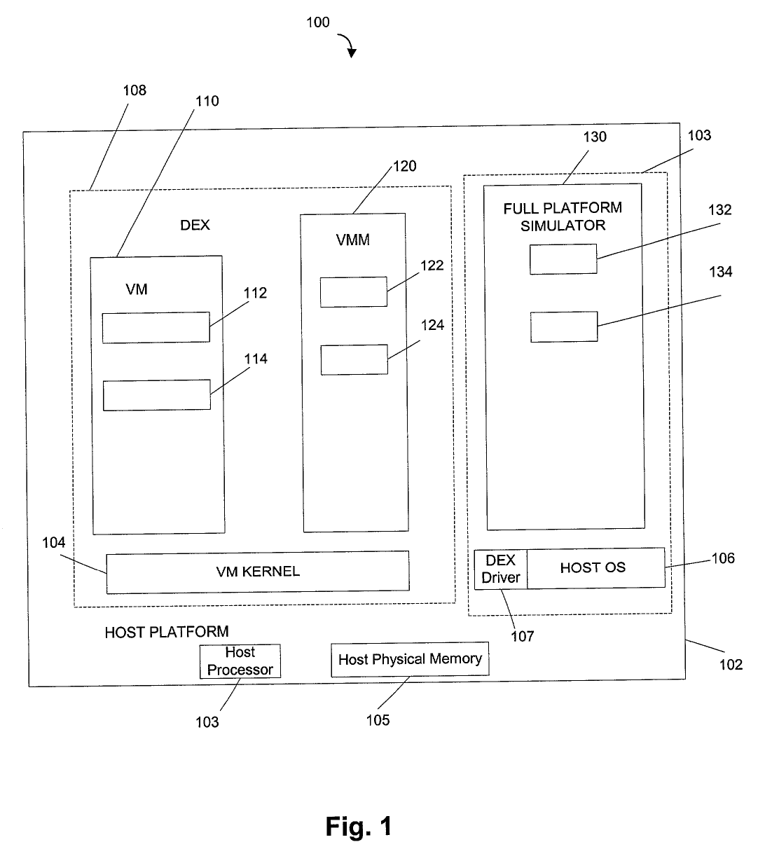

FIG. 1 shows a platform simulation environment 100 running on top of a host platform 102. The simulation environment 100 includes a host environment 103 and a direct execution environment (DEX) 108. Both the host environment 103 and the DEX 108 can be implemented entirely in software.

The host environment 103 includes a host OS 106 and a full PC platform simulator 130. The full platform simulator 130 can include a software development environment such as SoftSDV from Intel corporation of Santa Clara, Calif. or other types of full platform simulators such as the Virtutech Simics available from Virtutech of Stockholm, Sweden and Bochs from Solutionforge.net, VA Linux Systems of Fremont, Calif. or any other full platform simulators available from any other source. The full platform simulator 130 also includes one or more device models 132. The device models 132 simulate various I/O devices such as a video controller or other type of I/O device.

The host environment 103 also includes a DEX driver 107. The DEX driver 107 serves as an interface between host environment 103 and the DEX 108. The VMM 120 includes a binary translator 122. The VMM 120 can also include an auxiliary ISA simulator 124.

In one embodiment, the full platform simulator 130 operates in the host environment to execute a guest OS code. The full platform simulator 130 passes simulation control of the host platform 102 to the DEX 108 where the target CPU is simulated. When the target CPU accesses a simulated device, such as a video controller with a memory buffer, the DEX 108 passes simulation control back to the full platform simulator 130. After handling the simulated device access, the full platform simulator 130 passes simulation control back to the DEX 108. The device models 132 in the full platform simulator 130 cannot be relocated to DEX 108 because the device models 132 intensively use the host OS 106 services for device simulation (e.g. disk, graphics, keyboard, mouse, etc.).

The DEX 108 includes a virtual machine kernel (VMK) 104, a virtual machine (VM) 110, and a virtual machine monitor (VMM) 120. The VM 110 represents the target CPU and the guest OS code 112 runs in the VM 110. Many of the simulated instructions can be executed directly on the host CPU 103. The VMM 120 monitors the VM 110 execution. The VMM 120 is responsible to give the guest OS 112 the illusion that the guest OS 112 controls all of the target platform resources.

In one embodiment, the VM 110 and VMM 120 run in privilege level 3 (user privilege level). The VMK 104 runs in privilege level 0 (system privilege level). The VMK 104 is mapped in both VM 110 and VMM 120 address spaces. The VMK 104 is responsible to catch all exceptions, software and hardware interrupts occurring in the VM 110 and in the VMM 120. When a real hardware interrupt occurs, the VMK 104 passes control to host OS 106 for handling the interrupt. The VMK 104 forwards all exceptions and software interrupts coming from VM 110 to the VMM 120 for handling. The exceptions that occur in VMM 120 can also cause a failure of the simulation.

The VM 110 described above can be used to simulate any ISA such as IA32, IA64 or other ISAs.

The ISA simulator 134 in full platform simulator 130 simulates the I/O access, interacting with the appropriate device model 132 such as a video controller peripheral or other peripheral device. Control is then transferred back to the DEX 108, which resumes the simulation. As will be described in more detail below, the overhead and resultant delays of the I/O simulation are reduced. In one embodiment, a memory mapped device buffer is mapped in the virtual address spaces of both the device model 132 and the virtual machine 110 to the same location in the host physical memory system 105.

The memory-mapped region of a simulated device model 132 is allocated from the host physical memory 105 and mapped to the virtual address space of the full platform simulator 130 by the DEX driver 107. The same physical memory region is also mapped to the virtual address space of the VM 110. For example, a buffer in a simulated video controller in the VM 110 and a corresponding buffer in a simulated video controller device model 132 are mapped to the same physical memory location in the memory system 105. The DEX 108 and the full platform simulator 130 can both access the same buffer directly.

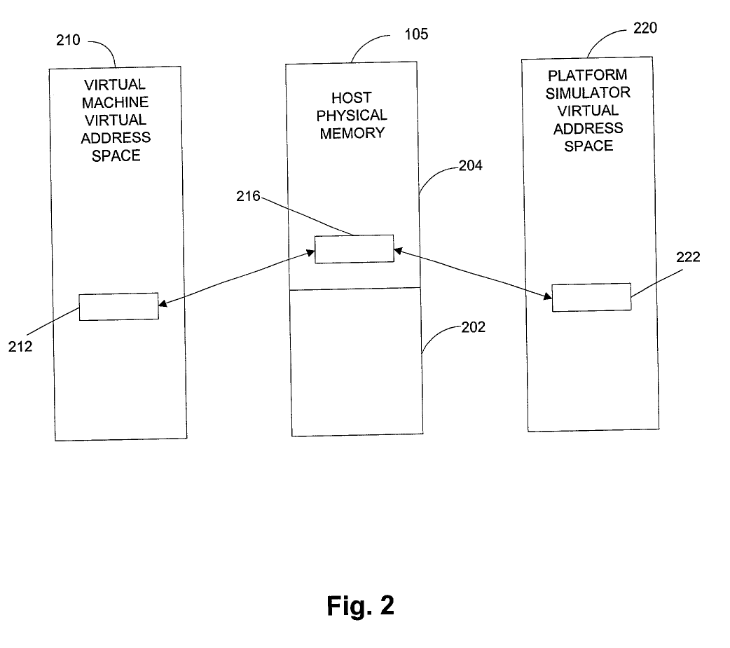

FIG. 2 illustrates one embodiment of mapping a virtual buffer 212 in the virtual address space 210 of the simulated ISA in the virtual machine 110 and the virtual buffer 222 in a device model 132 to the same location 216 in the physical memory 105.

In one embodiment, the host physical memory 105 can be partitioned between the host platform 102 and the DEX 108. One partition 202 of the memory system 105 is allocated to the host OS 106. A second partition 204 of the memory system 105 is allocated to the DEX 108 and is therefore not visible to the host OS 106. The actual size of the partitions 202, 204 is dependant upon the size of the virtual address space 210 to be simulated by the DEX 108.

Using DEX driver 107, the partition 204 allocated to the DEX 108 is mapped into the full platform simulator's 130 virtual address space 220 and is used as a memory allocation pool for simulated physical memory 220 and memory mapped device buffers. In particular, memory for a device model 222 (e.g. a video buffer) is allocated from this pool. For example, when the DEX 108 stores or fetches data in a simulated video buffer 212 in a virtual video controller, the data is stored or fetched from the mapped physical memory location 216. The DEX 108 can access the physical memory location 216 without transferring control to the fall platform simulator 130.

However, when a function must be performed in the virtual video controller, then simulation control of the host platform 102 is transferred to the full platform simulator 130. The full platform simulator 130 then performs a simulated operation in the virtual video controller device model. Then the control of the host platform 102 is transferred back to the DEX 108.

Because a particular virtual buffer in the DEX 108 is mapped to the same physical memory location as the corresponding virtual buffer in the full platform simulator 130, then the DEX 108 can access (i.e. fetch and store) the virtual buffer 216 without transferring control to the full platform simulator 130. This allows for faster operation of the processor simulation running in the DEX 108.

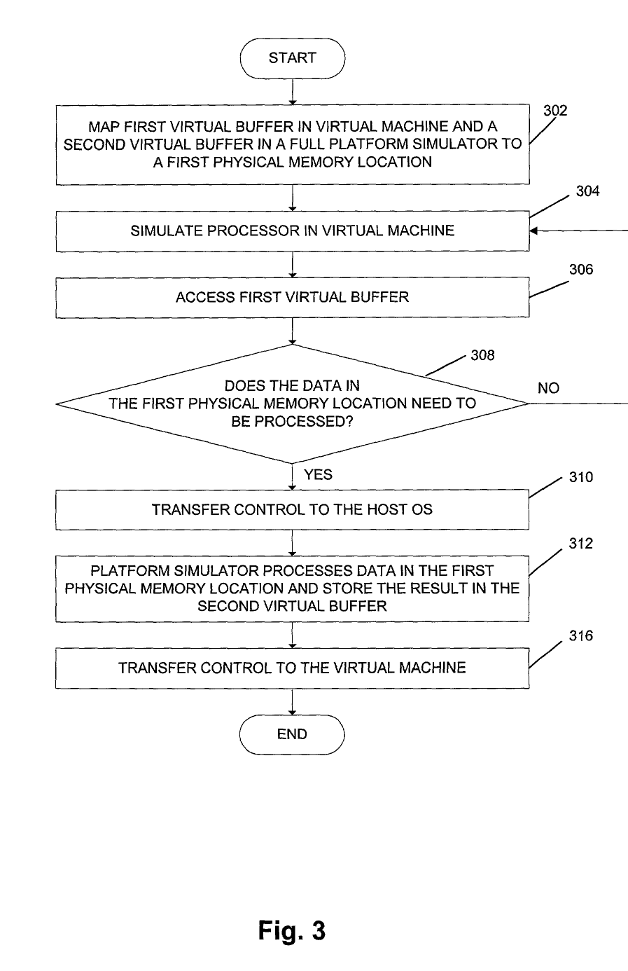

FIG. 3 illustrates one embodiment of a process for accessing the virtual buffer in a simulated ISA. A first virtual buffer in a simulated processor is mapped to a physical memory location in block 302. A second virtual buffer in a simulated device model is also mapped to the same physical memory location in block 302. As described above, the second virtual buffer corresponds to the first virtual buffer. In block 304 the processor is simulated in a virtual machine. The simulated processor fetches data from or stores data in the virtual buffer that is mapped to the physical memory location in block 306.

In block 308, if the data in the first virtual buffer must be processed before the simulated processor can continue to process, then the control of the host platform is transferred to the host OS in block 310. When the control of the host platform is transferred to the host OS, a corresponding device model in the platform simulator can process the data stored in the second virtual buffer/first physical memory location. The result of the processed data is then stored in the second virtual buffer/first physical memory location in block 312. Control of the host platform is then transferred back to the virtual machine in block 316 so that the virtual machine can continue simulating the CPU.

If, in block 308, the data in the first physical memory location does not need to be processed, then the virtual machine continues to simulate a processor in block 304.

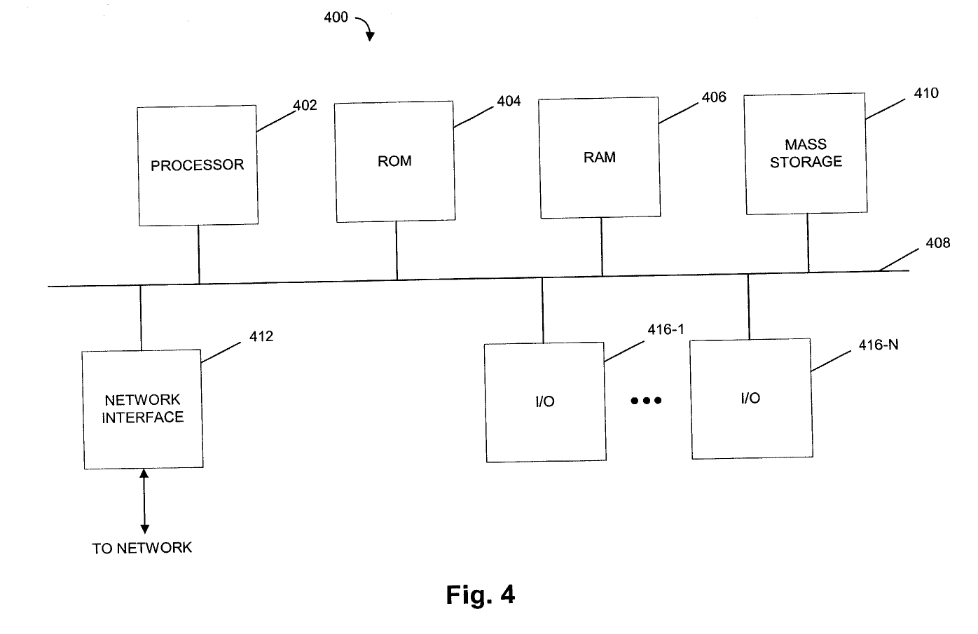

FIG. 4 illustrates one embodiment of a high-level block diagram of a computer system that could be used as the host platform 102 described in FIG. 1 above. As shown, the computer system 400 includes a processor 402, ROM 404, and RAM 406, each connected to a bus system 408. The bus system 408 may include one or more buses connected to each other through various bridges, controllers and/or adapters, such as are well known in the art. For example, the bus system 408 may include a “system bus” that is connected through an adapter to one or more expansion buses, such as a Peripheral Component Interconnect (PCI) bus. Also coupled to the bus system 408 are a mass storage device 410, a network interface 412, and a number (N) of input/output (I/O) devices 416-1 through 416-N.

I/O devices 416-1 through 416-N may include, for example, a keyboard, a pointing device, a display device and/or other conventional I/O devices. Mass storage device 410 may include any suitable device for storing large volumes of data, such as a magnetic disk or tape, magneto-optical (MO) storage device, or any of various types of Digital Versatile Disk (DVD) or Compact Disk (CD) based storage.

Network interface 412 provides data communication between the computer system and other computer systems such as the Internet. Hence, network interface 412 may be any device suitable for or enabling the computer system 400 to communicate data with a remote processing system over a data communication link. The network interface 412 can include a conventional telephone modem, an Integrated Services Digital Network (ISDN) adapter, a Digital Subscriber Line (DSL) adapter, a cable modem, a satellite transceiver, an Ethernet adapter, a cellular telephone receiver transmitter or the like.

Of course, many variations upon the architecture shown in FIG. 4 can be made to suit the particular needs of a given system. Thus, certain components may be added to those shown in FIG. 4 for a given system, or certain components shown in FIG. 4 may be omitted from the given system.

It will be further appreciated that the instructions represented by the blocks in FIG. 3 are not required to be performed in the order illustrated, and that all the processing represented by the blocks may not be necessary to practice the invention. Further, the processes described in FIG. 3 can also be implemented in software stored in any one of or combinations of the ROM 404, the RAM 406 and/or the mass storage device 410.

One skilled in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method of simulating an I/O access comprising:
simulating a processor in a virtual machine, wherein the virtual machine is operating on a host platform;
accessing a first virtual buffer in a simulated I/O device by the simulated processor; and
mapping the first virtual buffer and a second virtual buffer to a first physical memory location in the host platform.

2. The method of claim 1, further comprising simulating a platform, wherein the simulated platform operates on a host operating system on the host platform and wherein the platform simulator includes the second virtual buffer and wherein the second virtual buffer corresponds to the first virtual buffer.

3. The method of claim 1, further comprising transferring control of the host platform from the virtual machine to the host operating system.

4. The method of claim 1, wherein accessing the first virtual buffer includes saving data to the first virtual buffer.

5. The method of claim 1, wherein accessing the first virtual buffer includes fetching data from the first virtual buffer.

6. The method of claim 1, wherein the host platform includes:
a host processor; and
a host memory system.

7. The method of claim 6, wherein the host memory system is partitioned into a plurality of partitions.

8. The method of claim 7, wherein the plurality of partitions includes a first partition designated for the host operating system.

9. The method of claim 7, wherein plurality of partitions includes a second partition designated for the simulated processor.

10. The method of claim 9, wherein an platform simulator includes access to the second partition.

11. The method of claim 1, wherein the virtual machine operates on a virtual machine kernel.

12. The method of claim 1, wherein simulated processor includes an IA32 processor.

13. The method of claim 1, wherein simulated processor includes an IA64 processor.

14. A system for simulating an I/O access comprising:
a host platform, wherein the host platform includes a host processor and a host memory system;
a virtual machine kernel hosted on the host platform;
a virtual machine, wherein the virtual machine includes a processor simulator, wherein the processor simulator includes a first virtual buffer, wherein the first virtual buffer is mapped to a first physical memory location in the host memory system;
a virtual machine monitor, wherein the virtual machine and the virtual machine monitor are hosted on the virtual machine kernel;
a host operating system hosted on the host platform; and
a platform simulator wherein the platform simulator includes second virtual buffer, wherein the second virtual buffer is mapped to the first physical memory location in the host memory system, and wherein the platform simulator is hosted on the host operating system.

15. The system of claim 14, wherein the host memory system is partitioned into a plurality of partitions.

16. The system of claim 15, wherein the plurality of partitions includes a first partition designated for the host operating system.

17. The system of claim 15, wherein plurality of partitions includes a second partition designated for the simulated processor.

18. The system of claim 17, wherein the platform simulator includes access to the second partition.

19. The system of claim 14, wherein simulated processor includes an IA32 processor.

20. The system of claim 14, wherein simulated processor includes an IA64 processor.

21. The system of claim 14, wherein simulated platform includes a SoftSDV system.

22. A system for simulating an I/O access comprising:
a processor;
a storage facility coupled to the processor and containing instructions executable by the processor which configure the system to:
simulate a processor in a virtual machine, wherein the virtual machine is operating on a host platform;
access a first virtual buffer in a simulated I/O device by the simulated processor; and
map the first virtual buffer and a second virtual buffer to a first physical memory location in the host platform.

23. The system of claim 22, wherein the storage facility coupled to the processor and containing instructions executable by the processor further configures the system to:
simulate an Full platform, wherein the simulated platform operates on a host operating system on the host platform and wherein the platform simulator includes the second virtual buffer and wherein the second virtual buffer corresponds to the first virtual buffer.

24. The system of claim 22, wherein the host memory system is partitioned into a plurality of partitions.

25. The system of claim 24, wherein the plurality of partitions includes a first partition designated for the host operating system.

26. The system of claim 24, wherein plurality of partitions includes a second partition designated for the simulated processor.

27. The system of claim 22, wherein simulated processor includes an IA32 processor.

28. The system of claim 22, wherein simulated processor includes an IA64 processor.
